SEQUENCE LISTING (11 sequences)

SEQ ID NO: 1 - protein, 29 aa, Artificial Sequence
  Synthetic polypeptide
TLISWIKNKRKQRPRVSRRRRRRGGRRRR

SEQ ID NO: 2 - protein, 32 aa, Artificial Sequence
  Synthetic polypeptide
PRRRRSSSRPVRRRRRPRVSRRRRRRGGRRRR

SEQ ID NO: 3 - protein, 11 aa, Artificial Sequence
  Synthetic polypeptide
RRWQWRMKKLE

SEQ ID NO: 4 - protein, 29 aa, Artificial Sequence
  Synthetic polypeptide
RPRVSRRRRRRGGRRRRTLISWIKNKRKQ

SEQ ID NO: 5 - protein, 12 aa, Artificial Sequence
  Synthetic polypeptide
TLISWIQRPRVS

SEQ ID NO: 6 - protein, 17 aa, Artificial Sequence
  Synthetic polypeptide
TLISWIKNKRKQRPRVS

SEQ ID NO: 7 - protein, 24 aa, Artificial Sequence
  Synthetic polypeptide
TLISWIQRPRVSRRRRRRGGRRRR

SEQ ID NO: 8 - protein, 17 aa, Artificial Sequence
  Synthetic polypeptide
KNKRKRRRRRRGGRRRR

SEQ ID NO: 9 - protein, 30 aa, Artificial Sequence
  Synthetic polypeptide
CTLISWIKNKRKQRPRVSRRRRRRGGRRRR

SEQ ID NO: 10 - protein, 30 aa, Artificial Sequence
  Synthetic polypeptide
TLISWIKNKRKQRPRVSRRRRRRGGRRRRC

SEQ ID NO: 11 - protein, 30 aa, Artificial Sequence
  Synthetic polypeptide
TLISWIKNKRKQCRPRVSRRRRRRGGRRRR

(19) United States
(12) Patent Application Publication
(10) Pub. No.: US 2014/0315789 A1
(43) Pub. Date: Oct. 23, 2014

(54) ANTIMICROBIAL PEPTIDES AND USES THEREOF

(71) Applicants: NEWSOUTH INNOVATIONS PTY LIMITED, New South Wales (AU); BRIEN HOLDEN VISION INSTITUTE, New South Wales (AU)

(72) Inventors: Mark Duncan Willcox, Balmain (AU); Neresh Kumar, Maroubra (AU); Nerida Cole, Hornsby (AU); Renxum Chen, Carramar (AU)

(21) Appl. No.: 14/360,376

(22) PCT Filed: Nov. 21, 2012
(86) PCT No.: PCT/IB2012/056599

§ 371 Date: May 23, 2014

(30) Foreign Application Priority Data
Nov. 23, 2011 (AU) 2011904886

(51) Int. Cl. A01N 43/38

(52) U.S. Cl. CPC A01N 43/38
USPC 514/2.7; 530/324; 514/2.3; 525/54.1; 514/2.4; 514/2.8

(57) ABSTRACT

The present disclosure relates generally to antimicrobial peptides, methods for their use, and methods for preparing devices having surfaces which are modified to incorporate OH said peptides. In some embodiments, the antimicrobial peptides are antimicrobial OH cationic peptides modified to comprise a thiol functional group.

### CROSS-REFERENCE TO RELATED APPLICATIONS

The present application claims the benefit of priority of Australian Provisional Patent Application No. 2011904886, filed Nov. 23, 2011, the entirety of which is incorporated by reference as though fully set forth herein.

### REFERENCE TO A “SEQUENCE LISTING,” A TABLE, OR A COMPUTER PROGRAM LISTING APPENDIX SUBMITTED AS AN ASCII TEXT FILE

The Sequence Listing written in file 62367-853343_ST25.TXT, created on Nov. 19, 2012, 3,885 bytes, machine format IBM-PC, MS-Windows operating system, is hereby incorporated by reference.

### TECHNICAL FIELD

The present disclosure relates generally to antimicrobial peptides, methods for their use, and methods for preparing devices having surfaces which are modified to incorporate said peptides.

### BACKGROUND

The use of biomaterial implants and medical devices is becoming increasingly common Recent estimates suggest that up to 150 million intravascular devices and 1.25 million hip and knee replacements are performed in the United States each year. Infection is the most common reason for failure of implanted devices and infections associated with implanted devices account for approximately 45% of all nosocomial infections.

Infections associated with implanted devices are often highly resistant to antibiotics and immune responses which may result in severe consequences for the receiver of the device, including functional loss, amputation of an affected limb or, in extreme circumstances, even death. There is therefore a clear need to develop medical devices having improved antimicrobial properties.

To this end there is increasing interest in the development of antimicrobial surface coatings. One approach to such coatings calls for the inclusion of conventional antibiotics, silver or silver nanoparticles, quaternary ammonium compounds or salicylic acid. These types of coatings have however met with limited success and suffer from a number of disadvantages. For example, it has been observed that systems designed to release antibiotics at potentially sub-inhibitory concentrations without strict guidelines select for resistant mutants, which is compounded by biofilm formation. Furthermore, the presence of sub-inhibitory concentrations of antibiotics can, in some instances, increase biofilm formation. Additional problems associated with known antimicrobial surface coatings include cytotoxicity, anaphylaxis and lack of effect in vivo.

Against this background the present inventors have surprisingly discovered that selected cationic peptides which have been modified to comprise a thiol functional group possess improved antimicrobial activity, particularly when attached to a surface.

### SUMMARY

In a first aspect, the present disclosure provides an antimicrobial cationic peptide modified to comprise a thiol functional group.

The peptide may be modified to include a thiol functional group by introduction of a thiol-containing residue into the peptide. In one embodiment the thiol-containing residue is cysteine. The cysteine residue may be introduced into the peptide at the C-terminus or at the N-terminus. In a particular embodiment the thiol functional group may facilitate attachment of the peptide to a surface.

In some embodiments, the peptide may be arginine rich. In some such embodiments, the peptide may be arginine rich in the C-terminal portion. In some such embodiments, the peptide may comprise at least 10%, or at least 20%, or at least 30%, or at least 40% arginine, based on the total number of amino acids in the peptide.

In some embodiments, the peptide may be arginine and lysine rich. In some such embodiments, the peptide may be arginine and lysine rich in the C-terminal portion. In some embodiments, the peptide may comprise at least 10%, or at least 20%, or at least 30%, or at least 40%, or at least 50% arginine and lysine, based on the total number of amino acids in the peptide.

In some embodiments, the peptide may comprise between about 10 and about 60 amino acids. In some embodiments, the peptide that is modified may be melimine, protamine, lactoferricin, protattin, or a peptide comprising one of the following amino acid sequences:

(SEQ ID NO: 5)
TLISWIQRPRVS;
(SEQ ID NO: 6)
TLISWIKNKRKQRPRVS;
(SEQ ID NO: 7)
TLISWIQRPRVSRRRRRRGGRRRR;
and
(SEQ ID NO: 8)
KNKRKRRRRRRGGRRRR.

In some embodiments, the melimine peptide may have the amino acid sequence set forth in SEQ ID NO: 1, the protamine peptide may have the amino acid sequence set forth in SEQ ID NO: 2, the lactoferricin peptide may have the amino acid sequence set forth in SEQ ID NO: 3, and the protattin peptide may have the amino acid sequence set forth in SEQ ID NO: 4.

In some embodiments, the modified peptide may comprise one of the following amino acid sequences:

(SEQ ID NO: 9)
CTLISWIKNKRKQRPRVSRRRRRRGGRRRR,
(SEQ ID NO: 10)
TLISWIKNKRKQRPRVSRRRRRRGGRRRRC,
or
(SEQ ID NO: 11)
TLISWIKNKRKQCRPRVSRRRRRRGGRRRR.

In a second aspect, the present disclosure provides an antimicrobial composition comprising a cationic peptide as defined in the first aspect

In a third aspect, the present disclosure provides a method for improving the antimicrobial activity of an antimicrobial cationic peptide, the method comprising modifying the peptide to include a thiol functional group.

The peptide may be modified to include a thiol functional group by introduction of a thiol-containing residue into the peptide. In some embodiments, the thiol-containing residue may be cysteine. In some such embodiments, the cysteine residue may be introduced into the peptide at the C-terminus or at the N-terminus.

In some embodiments, the peptide may be as defined in the first aspect.

In a fourth aspect, the present disclosure provides a method for eliminating or inhibiting the growth of one or more microorganisms or the colonisation of an environment by the microorganisms, the method comprising contacting the one or more microorganisms, or an environment inhabited by the microorganisms, with an effective amount of a cationic peptide as defined in the first aspect.

In a fifth aspect the present disclosure provides a method for inhibiting the adherence of one or more microorganisms to a surface, the method comprising attaching to the surface at least one modified antimicrobial cationic peptide according to the first aspect, wherein the peptide is directly or indirectly attached to the surface via the thiol functional group of the modified peptide.

In some embodiments, the thiol functional group may be part of a cysteine residue. In some such embodiments, the cysteine residue may be located at the N-terminus or C-terminus of the modified peptide.

In some embodiments, the surface may be a solid surface. In some such embodiments, the solid surface may be colonised by, or be capable of being colonised by, the microorganisms.

In some embodiments, the peptide may be directly or indirectly covalently attached to the surface via the thiol functional group.

In some embodiments, the peptide may be indirectly covalently attached to the surface via a succinimidylene linker attached to the thiol functional group. In some such embodiments, the peptide may be indirectly covalently attached to the surface via a —NH(C═O)CH₂— linker attached to the thiol functional group.

In some embodiments, the peptide may be indirectly covalently attached to the surface via a succinimidylene linker attached to the thiol functional group and a spacer molecule attached to the succinimidylene linker and, directly or indirectly, to the surface. In some embodiments, the spacer molecule may be C₁-C₂₀ perfluoroalkylene, C₃-C₆ cycloalkylene, C₁-C₂₀alkylene, polyethylene glycol, or combinations thereof. In some other embodiments, the spacer molecule is C₃-C₆ cycloalkylene, C₁-C₆ alkylene, polyethylene glycol having between 2 and 20 ethylene glycol units, or combinations thereof.

In some embodiments, the spacer molecule may have the following structure:

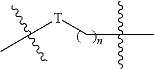

wherein T is —(CH₂CH₂O)ₘ—, C₁-C₆ alkylene or C₃-C₆ cycloalkylene, where n is a number between 0 and 5 and m is a number between 1 and 10. In some other embodiments, T is C₁-C₆ alkylene or C₃-C₆ cycloalkylene, and n is 0, 1, 2 or 3.

In some embodiments, the spacer molecule may be indirectly attached to the surface via a bivalent functional group comprising an amide.

In some embodiments, the bivalent functional group comprising an amide is a group of the following formula:

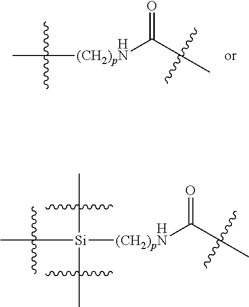

wherein p is a number between 1 and 6.

In some embodiments, the peptide may be attached to the surface via the following groups:

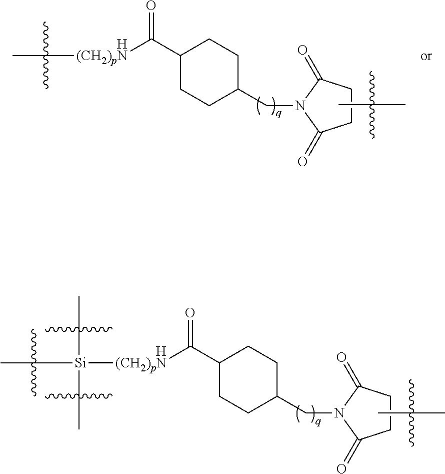

wherein p is a number between 1 and 3 and q is a number between 0 and 2. In some other embodiments, p is 3 and q is 1.

In some embodiments, the solid surface may comprise a polymer, for example a hydrogel, a silicon hydrogel, a polymer or copolymer of 2-hydroxyethylmethacrylate, silicon rubber, polyurethane, polypropylene, polyethylene, polyacrylamide, polytetrafluoroethylene (Teflon), or a biodegradable polymer, such as poly-lactide.

In some embodiments, the solid surface may be the surface of a medical device. The medical device may be, for example, a contact lens, fluid collection bag, sensor, hydrogel bandage, tubing, stent, heart valve, an implant, such as a hearing implant, a knee implant, a hip implant, an implantable electrode, an implantable neuroprosthetic electrode array, a catheter or carrier for antibiotic, diagnostic or therapeutic agents. In some embodiments, the contact lens may be a silicon hydrogel contact lens. In some embodiments, the medical device is a hearing implant.

In some embodiments, the solid surface may be a glass or metal surface or a metal-containing surface, for example a transition metal surface or a transition metal-containing surface. In at least one such embodiment, the transition metal is titanium.

In some embodiments, the one or more microorganisms may be selected from bacteria, fungi, yeast and protozoa. In some such embodiments, the one or more microorganisms are bacteria and the bacteria may be Gram-negative or Gram-positive bacteria. In some such embodiments, the bacteria are Staphylococcus aureus or Pseudomonas aeruginosa.

In a sixth aspect, the present disclosure provides a device, wherein the surface of the device comprises at least one modified antimicrobial cationic peptide according to the first aspect, wherein the peptide is directly or indirectly attached to the surface of the device via the thiol functional group of the modified peptide.

In some embodiments, the peptide may be attached to the device as defined in embodiments of the fifth aspect.

In some embodiments, the device may be a medical device, for example, a contact lens, fluid collection bag, sensor, hydrogel bandage, tubing, stent, heart valve, an implant, such as a hearing implant, a knee implant, a hip implant, an implantable electrode, an implantable neuroprosthetic electrode array, a catheter or carrier for antibiotic, diagnostic or therapeutic agents. In some such embodiments, the contact lens may be a silicon hydrogel contact lens. In some embodiments, the medical device is a hearing implant.

In some embodiments, the surface of the device may comprise a polymer, for example a hydrogel, a silicon hydrogel, a polymer or copolymer of 2-hydroxyethylmethacrylate, silicon rubber, polyurethane, polypropylene, polyethylene, polyacrylamide, polytetrafluoro-ethylene (TEFLON), or a biodegradable polymer, such as poly-lactide.

In a seventh aspect, the present disclosure provides a method for improving the activity of an antimicrobial cationic peptide as defined in the first aspect, the method comprising modifying the peptide to include a thiol functional group and attaching the peptide to a surface via the thiol functional group. In some embodiments, the surface may be a solid surface.

In some embodiments, the peptide may be modified to include a thiol functional group by introduction of a cysteine residue into the peptide. In some such embodiments, the peptide is modified to include a cysteine residue at the C-terminus or at the N-terminus of the peptide.

In an eighth aspect, the present disclosure provides a method for modulating the location of attachment of at least one antimicrobial cationic peptide as defined in the first aspect to a surface, the method comprising introducing a thiol functional group into the peptide at a position of the peptide where it is desired to attach the peptide to the surface. In some embodiments, the surface may be a solid surface.

In some embodiments, the thiol functional group may be introduced into the peptide as part of a cysteine residue. In some such embodiments, the cysteine residue may be introduced into the peptide at the C-terminus or at the N-terminus of the peptide.

In a ninth aspect, the present disclosure provides a method for preparing a device having at least one surface, the method comprising reacting the at least one surface with at least one modified antimicrobial cationic peptide as defined in the first aspect, wherein reaction occurs at the thiol functional group of the modified peptide.

In some embodiments, the device may be a medical device as defined above in any of the embodiments of the fifth aspect.

The surface of the device may comprise a polymer as defined above in any of the embodiments of the fifth aspect.

In some embodiments, the surface may comprise a maleimidyl group or a group of the formula —NH(C═O)CH₂— leaving group attached thereto which reacts with the thiol functional group. In some embodiments, the maleimidyl group or group of the formula —NH(C═O)CH₂-leaving group may be attached to the surface via a spacer molecule. The spacer molecule may be as defined above in any of the embodiments of the fifth aspect.

In some embodiments, the spacer molecule may be indirectly attached to the surface via a bivalent functional group comprising an amide as defined above in any of the embodiments of the fifth aspect.

### BRIEF DESCRIPTION OF DRAWINGS

Embodiments of the present disclosure will now be described, by way of example only, with reference to the accompanying drawings.

FIG. 1 shows site-directed attachment of cysteine-modified melimine on maleimide-functionalised glass (APTES refers to 3-aminopropyltriethoxysilane).

FIG. 2 shows a scoring plot of melimine-coated samples: CysN(CN), Cys13 (CM) and CysC(CC).

FIG. 3 shows loading plots of amino acid fragments for PC1 (blue) and PC2 (red). For each pair of bars, the PC1 is shown on the left and the PC2 is shown on the right. Each pair corresponds, from left to right, with R, S, P, T, N, V, R, V, Q, K, L/I, R, R, R, R, W, W, W, respectively.

FIG. 4 shows percentage surface coverage of live bacteria (green) and dead bacteria (red) for P. aeruginosa (A) and S. aureus (B). The green is shown in the lower portion of each bar, while the red is shown in the upper portion. BLK refers to a blank surface, MAL refers to maleimide-activated glass, ABA-MEL refers to melimine attached to a glass surface via a 4-azidobenzoic acid group, CysN refers to melimine wherein an extra cysteine residue has been added to the N-terminus, Cys13 refers to melimine wherein an extra cysteine residue has been added to position 13 and CysC refers to melimine wherein an extra cysteine residue has been added to the C-terminus and error bars are standard errors for total coverage. Statistical significance at 95% confidence level to the blank is indicated by *, and ▴.

### DEFINITIONS

The following are some definitions that may be helpful in understanding the present description. These are intended as general definitions and should in no way limit the scope of the present disclosure to those terms alone, but are put forth for a better understanding of the following description.

Throughout this specification and the claims which follow, unless the context requires otherwise, the word “comprise”, and variations such as “comprises” or “comprising”, will be understood to imply the inclusion of a stated element, integer or step, or group of elements, integers or steps, but not the exclusion of any other element, integer or step, or group of elements, integers or steps.

In the context of this specification, the terms “a” and “an” are used herein to refer to one or to more than one (i.e. to at least one) of the grammatical object of the article. By way of example, “an element” means one element or more than one element.

In the context of this specification, the term “about,” is understood to refer to a range of numbers that a person of skill in the art would consider equivalent to the recited value in the context of achieving the same function or result.

In the context of this specification, the term “environment inhabited by” in the context of microorganisms encompasses any environment (solid, fluid or gaseous, including surfaces of cells, tissues, organs or inanimate objects) that is inhabited or colonised by, or is capable of being inhabited or colonised by, microorganisms.

In the context of this specification, the term “antimicrobial composition” is understood to mean a composition that is capable of eliminating, preventing, inhibiting or retarding the growth of at least one microorganism, the colonisation of an environment by the microorganism or the adherence to a surface by the microorganism.

In the context of this specification, the term “microorganism” is used in its broadest sense and is therefore not limited in scope to prokaryotic organisms. Rather, the term “microorganism” includes within its scope bacteria, archaea, yeast, fungi, protozoa and algae.

In the context of this specification, the term “effective amount” refers to an amount of the modified peptide which is sufficient to cause a Log reduction in the number of microorganisms of at least 1.0, which means that less than 1 microorganism in 10 remains. The modified peptides of the present disclosure may provide Log reductions in the number of microorganisms of at least about 2.0, or at least about 3.0, or at least about 4.0, or at least about 5.0, or at least about 6.0, or at least about 7.0.

In the context of this specification, the term “medical device” refers to any device that is designed for use within, or in contact with cells, tissue or organs of a human or animal body.

In the context of this specification, the term “C₁-C₂₀ alkylene” is understood to refer to a straight chain or branched chain bivalent hydrocarbon group having between 1 and 20 carbon atoms, for example methylene, ethylene, propylene, 2-methylpropylene, butylene, octylene, dodecylene and the like.

In the context of this specification, the term “C₁-C₂₀ perfluoroalkylene” is understood to refer to a C₁-C₂₀ alkylene group as defined above wherein all of the hydrogens are replaced by fluorine.

In the context of this specification, the term “C₁-C₆ alkylene” is understood to refer to a straight chain or branched chain bivalent hydrocarbon group having between 1 and 6 carbon atoms, for example methylene, ethylene, propylene, 2-methylpropylene, butylene, and the like.

In the context of this specification, the term C₃-C₆ cycloalkylene is understood to refer to a cyclic bivalent hydrocarbon group, for example cyclopropylene and cyclohexylene.

### DETAILED DESCRIPTION

In one aspect, the present disclosure provides an antimicrobial cationic peptide modified to comprise a thiol functional group. In another aspect the present disclosure provides a method for improving the antimicrobial activity of an antimicrobial cationic peptide, the method comprising modifying the peptide to include a thiol functional group. In some embodiments, the peptide may be modified to include a thiol functional group by introduction of any residue that comprises a thiol functional group, such as, for example, a cysteine residue or a thiol-containing beta amino acid. Alternatively, in some other embodiments, the peptide may be modified by introducing a thiol functional group into one or more of its constituent amino acids. In some such embodiments, the thiol functional group or residue that comprises a thiol functional group may be introduced into the peptide at any position, and in embodiments of the disclosure is introduced at the C-terminus or at the N-terminus of the peptide. In some such embodiments, a cysteine residue is introduced at the C-terminus or at the N-terminus of the peptide.

Peptides that may be modified, in accordance with some embodiments, may be arginine rich, and in particular embodiments are arginine rich in the C-terminal portion. In some embodiments, the peptide may comprise at least 10%, or at least 15%, or at least 20%, or at least 25%, or at least 30%, or at least 35%, or at least 40% arginine, based on the total number of amino acids in the peptide.

Peptides that may be modified, in accordance with some embodiments, may be arginine and lysine rich, and in particular embodiments are arginine and arginine rich in the C-terminal portion. In some embodiments, the peptide may comprise at least 10%, or at least 15%, or at least 20%, or at least 25%, or at least 30%, or at least 35%, or at least 40%, or at least 50% arginine and lysine, based on the total number of amino acids in the peptide.

In some embodiments, the peptide may comprise between about 10 and about 60 amino acids, or between about 10 and about 50 amino acids, or between about 10 and about 45 amino acids, or between about 10 and about 40 amino acids, or between about 10 and 35 amino acids.

Peptides that may be modified in accordance with some embodiments of the present disclosure include melimine, protamine, lactoferricin, and protattin. In some such embodiments, the peptide is melimine. In some embodiments, the melimine peptide comprises or consists of the amino acid sequence set forth in SEQ ID NO:1, the protamine peptide comprises or consists of the amino acid sequence set forth in SEQ ID NO:2, the lactoferricin peptide comprises or consists of the amino acid sequence set forth in SEQ ID NO:3, and the protattin peptide comprises or consists of the amino acid sequence set forth in SEQ ID NO:4.

In some embodiments of the disclosure, the cationic peptide melimine of SEQ ID NO:1 is modified to include a cysteine residue at position 13. It is to be understood that such a modification refers to the inclusion of a cysteine residue at position 13 as opposed to replacement of the amino acid residing at position 13 of the unmodified peptide.

In some particular embodiments, the modified melimine may comprise or consist of one of the following amino acid sequences:

(SEQ ID NO: 9)
CTLISWIKNKRKQRPRVSRRRRRRGGRRRR,
(SEQ ID NO: 10)
TLISWIKNKRKQRPRVSRRRRRRGGRRRRC,
or
(SEQ ID NO: 11)
TLISWIKNKRKQCRPRVSRRRRRRGGRRRR.

Also encompassed by the present disclosure is the modification of fragments of the peptides disclosed herein. The term “fragment” refers to a peptide that is a constituent of a peptide disclosed herein. Typically the fragment possesses qualitative biological activity in common with the peptide of which it is a constituent. For example, in some embodiments, fragments of melimine that may be modified include TLISWIQRPRVS (SEQ ID NO:5), TLISWIKNKRKQRPRVS (SEQ ID NO:6), TLISWIQRPRVSRRRRRRGGRRRR (SEQ ID NO:7) and KNKRKRRRRRRGGRRRR (SEQ ID NO:8).

Also encompassed by the present disclosure is the modification of variants of the peptides disclosed herein. The term “variant” as used herein refers to substantially similar sequences. Generally, peptide sequence variants possess qualitative biological activity in common. Further, these peptide sequence variants may share at least 90%, 91%, 92%, 93%, 94%, 95%, 96%, 97%, 98% or 99% sequence identity with peptides disclosed herein.

The modified peptides according to the present disclosure may be prepared using standard peptide synthesis methods that are well known to those skilled in the art. For example, the peptides may be synthesised by standard solution phase methodology, as described in Hruby, Victor J., Meyer, Jean-Philippe, Chemical synthesis of peptides. University of Arizona, USA. Editor(s): Hecht, Sidney, M. Bioorganic Chemistry: Peptides and Proteins (1998), pp 27-64, Oxford University Press, New York N.Y.

The modified peptides may also be synthesised by solid phase methodology using Boc chemistry, as described by Schnolzer et al., 1992, Int. J. Pept Protein Res. 40, 180-193. Following deprotection and cleavage from the solid support the reduced peptides may be purified using preparative chromatography.

The peptides may also be synthesised by solid phase methodology using Fmoc chemistry, for example as described below:
1) Peptide is synthesized by Fmoc solid-phase peptide synthesis using an automatic synthesizer.
2) Peptide is synthesized from its C-terminus by stepwise addition of amino acids.
3) the first Fmoc-amino acid is attached to an insoluble support resin via an acid labile linker.
4) After deprotection of Fmoc by treatment with piperidine, the second Fmoc-amino acid is coupled utilizing a pre-activated species or in situ activation.
5) After the desired peptide is synthesized, the resin bound peptide is deprotected and detached from the resin via TFA cleavage.
6) Following deprotection and cleavage from the solid support the reduced peptides are purified using preparative chromatography.

In accordance with the present disclosure, modified peptides may also be produced using standard techniques of recombinant DNA and molecular biology that are well known to those skilled in the art. Guidance may be obtained, for example, from standard texts such as Sambrook et al., Molecular Cloning: A Laboratory Manual, Cold Spring Harbor, N.Y., 1989 and Ausubel et al., Current Protocols in Molecular Biology, Greene Publ. Assoc. and Wiley-Intersciences, 1992. Methods described in Morton et al., 2000 (Immunol Cell Biol 78:603-607), Ryan et al., 1995 (J Biol Chem 270:22037-22043) and Johnson et al., 2005 (J Biol Chem 280:4037-4047) are examples of suitable purification methods for relaxin polypeptides, although the skilled addressee will appreciate that the present disclosure is not limited by the method of purification or production used and any other method may be used to produce relaxin for use in accordance with the methods and compositions of the present disclosure.

By way of example, a nucleotide sequence encoding the desired peptide sequence may be inserted into a suitable vector, operably linked to a suitable promoter, and the peptide expressed in an appropriate expression system. The host cell may be any suitable prokaryotic, yeast or higher eukaryotic cell. Appropriate host cells can be selected without undue experimentation by a person skilled in the art. The host cell may then be cultured in conventional nutrient media modified for inducing promoters, selecting transformants, or amplifying the genes encoding the desired sequences. Culture conditions, such as media, temperature, pH, and the like, can be selected without undue experimentation by the person skilled in the art. The cells may then be selected and assayed for the expression of the peptide using standard procedures.

Under some circumstances it may be desirable to undertake oxidative bond formation of the expressed peptide as a chemical step following peptide expression. This may be preceded by a reductive step to provide the unfolded peptide. Those skilled in the art will be capable of determining appropriate conditions for the reduction and oxidation of the peptide. The modified peptides of the present disclosure find use against a range of microorganisms, for example, bacteria, yeast, fungi, and protozoa.

The bacteria may be Gram-negative or Gram-positive bacteria, such as for example Staphylococcus spp., Streptococcus spp., Enterococcus spp., Acinetobacter spp., Pseudomonas spp., Proteus spp., Serratia spp., Escherichia spp., Salmonella spp., Klebsiella spp., Bacillus spp. and Listeria spp. Exemplary species include but are not limited to Staphylococcus aureus, methicillin-resistant Staphylococcus aureus (MRSA), Staphylococcus epidermidis, coagulase negative staphylococci, Enterococcus faecalis, Enterococcus faecium including vancomycin-resistant Enterococcus faecium, Streptococcus pneumoniae, Klebsiella pneumoniae, Haemophilus influenzae, Pseudomonas aeruginosa, Escherichia coli, Salmonella enterica, Salmonella typhi, Bacillus cereus, and Listeria monocytogenes.

Those skilled in the art will appreciate that the modified peptides may be useful in the control of other bacterial species in addition to those specifically recited above.

Yeast against which the modified peptides may find use include, but are not limited to, Candida albicans.

Fungi against which the modified peptides may find use include, but are not limited to, Fusarium spp.

Protozoa against which the modified peptides may find use include, but are not limited to, Acanthamoeba spp.

The present disclosure also relates to antimicrobial compositions comprising one or more modified peptides as defined herein. Compositions may be used to eliminate, reduce or inhibit microbial growth by allowing the composition to contact the microorganisms to be inhibited and/or the environment of the microorganisms. The compositions may be used in a range of different environments that are inhabited or colonised by, or susceptible to being inhabited or colonised by, unwanted microorganisms. The compositions may be adapted for application to a surface of an article or an area which may come into contact with, or is believed to harbour microorganisms. Examples of such articles and areas include, but are not limited to, surgical instruments, medical devices, medical establishments, such as doctor's surgeries and hospitals, and food preparation areas.

The compositions may take any suitable form depending on the intended use thereof. For example, the compositions may take the form of a solution which can be applied to a surface or area by spraying. Alternatively, the compositions may take the form of a solution into which articles may be immersed. In another embodiment the compositions may take the form of a wipe comprising the modified peptides which can be used to apply the modified peptides to a surface or article.

The present disclosure further provides methods for eliminating or inhibiting the growth of one or more microorganisms or the colonisation of an environment by the microorganisms, comprising contacting the one or more microorganisms, or an environment inhabited by the microorganisms, with an effective amount of a modified antimicrobial cationic peptide as disclosed herein. In order to facilitate contact of the microorganisms, or the environment inhabited by the microorganisms with the modified peptides, the modified peptides may be present in the form of a composition as described above. Alternatively, the modified peptides may be attached to a solid surface.

The present disclosure also relates to methods for inhibiting the adherence of one or more microorganisms to a surface, comprising attaching to the surface a modified antimicrobial cationic peptide as disclosed herein, wherein the peptide is directly or indirectly attached to the surface via the thiol functional group incorporated into the modified peptide. In particular embodiments the modified peptides are attached to a solid surface, for example the surface of a device, such as a medical device. The medical device may be, for example, a contact lens, fluid collection bag, sensor, hydrogel bandage, tubing, stent, heart valve, an implant, such as a hearing implant, a knee implant, a hip implant, an implantable electrode, an implantable neut. ° prosthetic electrode array (such as those manufactured by Cochlear), a catheter or carrier for antibiotic, diagnostic or therapeutic agents. Those skilled in the art will however appreciate that the modified peptides may be attached to the surface of other medical devices which are susceptible to contamination by microorganisms. In some embodiments, the modified peptides may also be attached to the surface of devices intended for use in fields other than the medical field. In some other embodiments, the modified peptides may be attached to surfaces located in food preparation areas, for example kitchens. The modified peptides may be attached to any solid surface that is susceptible to contamination by microorganisms.

The modified peptides may be covalently attached to a solid surface. Attachment of the modified peptides to the solid surface may be either direct or indirect. Indirect attachment may involve attachment via linker and/or spacer molecules. Suitable linkers and spacer molecules will be well known to those skilled in the art.

The solid surface may be suitably functionalised so as to facilitate direct covalent attachment of the modified peptide thereto. Functionalisation of the solid surface may be achieved by use of a reagent that activates a functional group of the surface such that this functional group is capable of reacting with a functional group of the modified peptide. For example, an amino or thiol group of the modified peptide may be reacted with an isothiocyanate, an acyl azide, an N-hydroxysuccinimide ester, an aldehyde, a tosylate, an imido ester or an aryl halide group of the surface. In such embodiments, the surface preferably comprises a polymer, such as a polymer described herein.

Indirect attachment of the modified peptides to the surface may be achieved by use of cross-linking reagents, for example 4-azidobenzoic acid, 4-fluoro-3-nitro-azidobenzene, N,N′-carbonyldiimidazole, and carbodiimides. Other suitable cross-linking reagents will be readily apparent to those skilled in the art.

In some embodiments, a linker is attached to the surface, the linker comprising or being, a functional group that is capable of reacting with the thiol functional group of the modified peptide. The linker may be a maleimide, which is able to undergo a Michael reaction with the thiol functional group thereby linking the modified peptide and the surface via a succinimidylene linker. The linker may be of the formula —NH(C═O)CH₂— leaving group, which is able to undergo nucleophillic attack by the thiol functional group thereby linking the modified peptide and the surface by an —NH(C═O)CH₂— linker. In alternative embodiments the modified peptide may be attached to the solid surface utilising native chemical ligation.

Indirect attachment of the modified peptide to the surface may also include the presence of a spacer located between the surface and the linker. The use of a spacer allows modulation of the distance between the surface and the modified peptide. Examples of spacers include, but are not limited to: alkylene, perfiuoroalkylene, polyethylene glycol, phenylene and cycloalkylene.

In one embodiment, the spacer may be C₁-C₂₀ perfluoroalkylene, C₃-C₆ cycloalkylene, C₁-C₂₀ alkylene, polyethylene glycol, or any combination thereof. These groups may be hydrophobic or hydrophilic. Alternatively, the spacer may be C₃-C₆ cycloalkylene, C₁-C₆ alkylene, polyethylene glycol having between 2 and 20 ethylene glycol units, or any combination thereof.

In another embodiment, the spacer has the following structure:

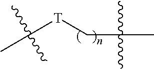

wherein T is —(CH₂CH₂O)ₘ—, C₁-C₆ alkylene or C₃-C₆ cycloalkylene, n is a number between 0 and 5 and m is a number between 1 and 10. In an alternative embodiment, T is C₁-C₆ alkylene or C₃-C₆ cycloalkylene, and n is 0, 1, 2 or 3. In another embodiment, T is C₃-C₆ cycloalkylene, and n is 1 or 2. In still a further embodiment, T is cyclohexylene, and n is 0 or 1.

The spacer molecule may be indirectly attached to the surface via a bivalent functional group comprising an amide. The spacer molecule may be attached to the surface via a C—C bond, a C—N bond, Si—O bond, Si—C bond, Ti—O bond or an amide.

In some embodiments, the bivalent functional group comprising an amide is a group of the following formula:

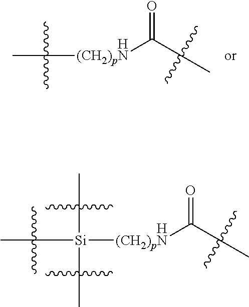

wherein p is a number between 1 and 6. In an alternative embodiment p is 2, 3 or 4. In still a further embodiment, p is 3.

In yet another embodiment of the disclosure the peptide may be attached to the surface via the following bivalent groups:

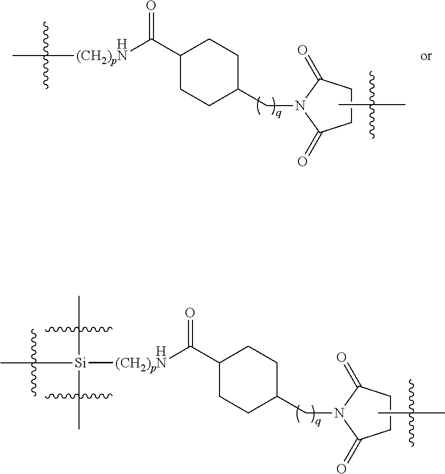

wherein p is a number between 1 and 3 and q is a number between 0 and 2. In an alternative embodiment, p is 3 and q is 1.

In the event that a solid surface does not possess suitable reactive functional groups for attachment of the modified peptide, such functional groups may be incorporated by conventional synthetic methods known to those skilled in the art. Alternatively, where the surface is a polymeric surface, appropriate reactive groups may be introduced thereto by the addition of polymerisable monomers comprising reactive groups into a monomer mixture used to prepare the polymer. Where the surface is not capable of chemical modification, plasma activation of the surface may be employed. Plasma modification may be appropriate where the surface does comprise reactive functional groups that are easily modified, or contains metal.

Examples of polymer surfaces onto which the modified peptides may be attached include surfaces formed from, for example, polymers and copolymers of styrene and substituted styrenes, ethylene, tetrafluoroethylene, propylene, acrylates and methacrylates, N-vinyl lactams, acrylamides and methacrylamides, acrylonitrile, acrylic and methacrylic acids as well as polyurethanes, polyester; polydimethylsiloxanes, biodegradable polymers, such as poly-lactide, and mixtures thereof. Such polymers may include hydrogels and silicone hydrogels.

In some embodiments, lightly crosslinked polymers and copolymers of 2-hydrovethylmethacrylate (“HEMA”) are used. By “lightly crosslinked” it is meant that the polymer has a sufficiently low crosslink density such that it is soft and elastic at room temperature. Typically, a lightly crosslinked polymer possesses about 0.1 to about 1 crosslinking molecules per about 100 repeating monomer units. Examples of suitable lightly crosslinked HEMA polymers and copolymers include, but are not limited to etafilcon A and copolymers of glycerol methacrylate and HEMA. Preferred silicone hydrogels include those comprising hydrophilic monomers, such as N,N-dimethylacrylamide.

In another aspect the present disclosure provides a method for preparing a device having at least one surface, the method comprising reacting the at least one surface with at least one modified antimicrobial cationic peptide as defined in the first aspect, wherein reaction occurs at the thiol functional group of the modified peptide.

In one embodiment the device is a medical device as defined herein. The surface of the device may comprise a polymer as defined herein. The surface may comprise a maleimidyl group or a group of the formula —NH(C═O)CH₂— leaving group attached thereto which reacts with the thiol functional group. The maleimidyl group or group of the formula —NH(C═O)CH₂— leaving group may be attached to the surface via a spacer molecule. The spacer molecule may be a. spacer molecule as defined above. The spacer molecule may be indirectly attached to the surface via a bivalent functional group comprising an amide as defined above.

In one embodiment the maleimidyl group is attached to the surface as follows:

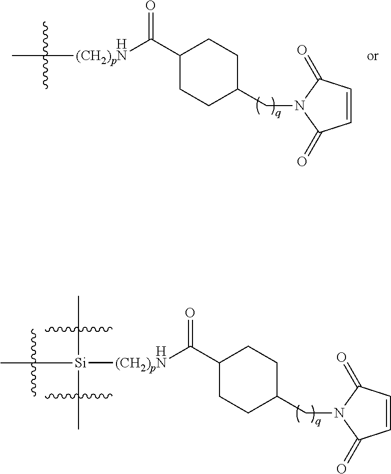

wherein p is a number between 1 and 3 and q is a number between 0 and 2. In an alternative embodiment, p is 3 and q is 1.

The present disclosure further provides a method for modulating the location of attachment of at least one antimicrobial cationic peptide as defined herein to a surface, the method comprising introducing a thiol functional group into the peptide at a position of the peptide where it is desired to attach the peptide to the surface. The surface may be a solid surface as described herein. The thiol functional group may be introduced into the peptide as described above in connection with other embodiments, for example as part of a cysteine residue. In one embodiment the cysteine residue is introduced into the peptide at the C-terminus or at the N-terminus of the peptide.

In yet another aspect the present disclosure provides a method for improving the activity of an antimicrobial cationic peptide as defined herein, the method comprising modifying the peptide to include a thiol functional group and attaching the peptide to a surface via the thiol functional group. The surface may be a solid surface as described herein. The peptide may be modified by introduction of a thiol functional group as described above in connection with other embodiments, for example by addition of a cysteine residue. In one embodiment the peptide is modified to include a cysteine residue at the C-terminus or at the N-terminus of the peptide.

Those skilled in the art will appreciate that the embodiments described herein are susceptible to variations and modifications other than those specifically described. It is to be understood that the disclosure includes all such variations and modifications which fall within the spirit and scope. The disclosure also includes all of the steps, features, compositions and compounds referred to or indicated in this specification, individually or collectively, and any and all combinations of any two or more of said steps or features.

Certain embodiments will now be described with reference to the following examples which are intended for the purpose of illustration only and are not intended to limit the scope of the generality hereinbefore described.

### EXAMPLES

### General Methods

### Synthesis of Peptides

Melimine (T L I S W I K N K R K Q R P R V S R R R R R R G G R R R R) was synthesized by conventional solid-phase peptide synthesis protocols and was obtained from American Peptide Company (CA, USA). Peptides with greater than 80% purity were used in experiments. An extra cysteine amino acid was added to either the N-terminus, position 13 or the C-terminus, and the resultant peptides were named CysN, Cys 13 and CysC respectively.

### 3-Aminopropyltriethoxylsilane (APTES) Attachment to Glass

Glass coverslips (No. 1, diameter 13 mm D263 Mglass, ProSciTech, Australia) were immersed in NaOH (2M) for 5 days, concentrated H₂SO₄ for 2 days, followed by sonication (Unisonics, FXP 10M, Australia) in distilled H₂O for 3×15 min The cleaned glass coverslips were stored in absolute ethanol before use. Cleaned glass coverslips were placed on steel mesh within a glass vessel. APTES (Sigma-Aldrich, St. Louis, Mo., USA) solution (10% w/v in dry toluene) was transferred into the glass vessel underneath the coverslips. The glass vessel was sealed and placed in an oven at 140° C. for 18 h, followed by rinsing with dry toluene (3×).

### Attachment of Peptides

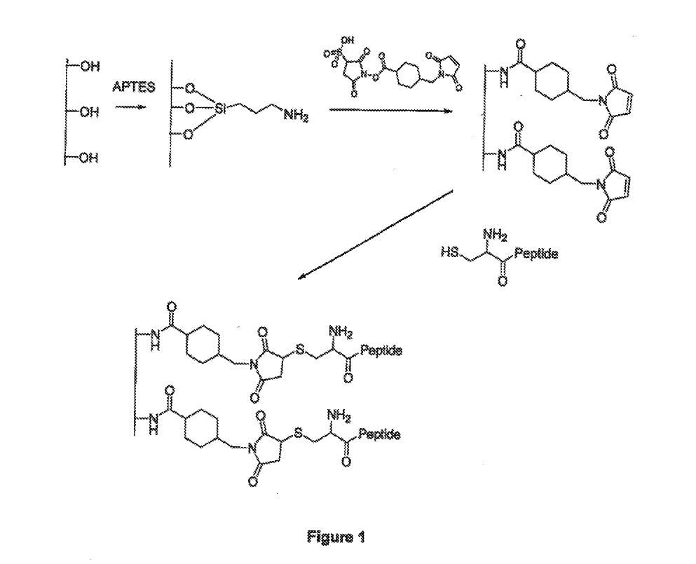

A schematic of the reaction steps is illustrated below in FIG. 1. A 2 mg/mL solution of 4-(N-maleimidomethyl)cyclohexane-1-carboxylic 3-sulfo-n-hydroxysuccinimide ester (crosslinker; Sulfo-SMCC, ProteoChem, Inc., CO, USA) was freshly prepared in phosphate-buffered saline-EDTA solution (PBS-EDTA, 50 mM phosphate, 0.15 M NaCl, 10 mM EDTA, pH 7.2). The APTES treated surfaces were then immersed in the crosslinker solution and incubated at room temperature for 1 hour. The surfaces were then rinsed with PBS-EDTA and subsequently air dried. The coverslips were then immersed in one of the three cys-melimine solutions (2 mg/mL in PBS-EDTA) for 24 hours and then washed with PBS-EDTA. The samples were air dried and then stored at room temperature until further use.

### Estimation of Peptide Concentration on the Modified Surfaces

The quantity of peptide attached to the surfaces was estimated by a direct dye binding method (Chen et al. Biofouling 2009, 25(6), pp 517-24 and Sonde M, et al. Analytical Biochemistry 1992, 200(1), pp 195-8. Measurements were made in triplicates with at least two repeats. Briefly, coated and uncoated glass surfaces were immersed in Bradford reagent (Biorad, CA, USA) and shaken for 15 minutes. The supernatant was removed and the absorbance measured at 465 nm. A standard curve was constructed from a solution of melimine according to the manufacturer's directions, but measured at 465 nm instead of 595 nm in order to determine the levels of remaining unbound dye at each concentration. Alternatively, peptide concentrations may be performed by amino acid analysis after acid hydrolysis of the amino acids from the surface.

### X-Ray Photoelectron Spectroscopy (Xps)

The samples were analysed using X-ray Photoelectron Spectroscopy (XPS; ESCALAB220-iXL, VG Scientific, West Sussex, England). The X-ray source was monochromated A1 Kα and the photo-energy was 1486.6 eV with a source power of 120 W. Vacuum pressure was ≦10-8 mbar.

### Time-of-Flight Secondary Ion Mass Spectrometry (ToF-SIMS)

Time-of-Flight Secondary Ion Mass Spectrometry (ToF-SIMS) is an analytical technique used to image and record organic and inorganic mass spectral data of solid materials. It involves the analysis of ionised particles that are emitted when the surface is bombarded with an energetic primary ion beam. Emitted particles are accelerated to constant kinetic energy into the time-of-flight chamber of a mass spectrometer, where mass separation is achieved according to mass-to-charge ratio. It is a highly sensitive technique that provides chemical information regarding elemental, isotopic and molecular structure from the first 1-2 monolayers (under static conditions).

ToF-SIMS experiments were performed using a Physical Electronics Inc. PHI TRIFT V nanoTOF instrument equipped with a pulsed liquid metal 79⁺ Au primary ion gun (LMIG), operating at 30 kV energy. Dual charge neutralisation was provided by an electron flood gun and 10 eV Ar⁺ ions. Surface analyses were performed using ‘bunched’ Aul beam settings to optimise mass resolution. Spectra were collected in positive and negative SIMS modes, using a 100×100 micron raster area. Typically, six analyses per sample in each polarity were collected to ensure a representative response from the surface was measured. Experiments were performed under a vacuum of 5×10⁻⁶ Pa or better.

### Data Analyses

ToF-SIMS spectra were calibrated using the Wincadence software (Physical Electronics Inc.) and peaks were selected based upon a previous ToF-SIMS study of protein (Baugh et al. Langmuir 2010, 26(21), pp 16434-41, Samuel et al. Surface Science Spectra 2001, 8(3), pp. 163-84, and Mantus et al. Analytical Chemistry 1993, 65(10), pp 1431-8) limited to peaks of amino acid fragments present in the sequence of melimine (Table 1).

TABLE 1
Peaks of selected amino acid fragments used for ToF-SIMS

| M/Z | Amino Acid | Formula |
|---|---|---|
| 43 | R | CH₃N₂ |
| 60 | S | C₂H₆NO |
| 68 | P | C₄H₆N |
| 69 | T | C₄H₅O |
| 70 | N | C₃H₄NO |
| 72 | V | C₄H₁₀N |
| 73 | R | C₂H₇N₃ |
| 83 | V | C₅H₇O |
| 84 | Q | C₄H₆NO |
| 84 | K | C₅H₁₀N |
| 86 | L/I | C₅H₁₂N |
| 100 | R | C₄H₁₀N₃ |
| 101 | R | C₄H₁₁N₃ |
| 112 | R | C₅H₁₀N₃ |
| 127 | R | C₅H₁₁N₄ |
| 130 | W | C₉H₈N |
| 159 | W | C₁₀H₁₁N₂ |
| 170 | W | C₁₁H₈NO |

Integrated peak values of the selected ions were normalised to the total selected secondary ion intensifies to correct for differences in total ion yield between analyses and samples. Data for each of the analyses were calculated, and then processed with Statsoft STATISTICA 7.

ToF-SIMS coupled with principal component analysis (PCA) allows careful examination of the subtle changes of the organic materials in the samples. This can be used to provide information about the identity, relative amount of absorption and conformation of amino acids attached to a surface.

### Bacterial Adhesion Experiments

Bacterial strains (Staphylococcus aureus strain 38 or Pseudomonas aeruginosa PA01) were streaked onto Chocolate agar (Oxoid, UK) and incubated overnight at 37° C. A single colony was cultured in 10 ml of tryptone soya broth (TSB) (Oxoid, UK) overnight to log phase at 37° C. Optical density of the resulting culture was adjusted to OD₆₆₀ of 0.1 (corresponding to 1×10⁸ cfu/ml) in TSB media (0.25% w/v glucose). Bacterial numbers were confirmed by a retrospective viable count.

Glass surfaces were placed in 4 ml of the above culture and incubated at 37° C. with shaking at 60 rpm for 24 hours, then the media was replaced with fresh TSB (4 ml) and incubated for a further 24 hours (total of 48 hours). The samples were then washed with PBS before examination by fluorescent staining

### Analysis of Bacterial Adhesion

Glass samples with adherent bacteria prepared as described above were stained with LIVE/DEAD BacLight Bacterial Viability Kit (Molecular Probes, Inc., OR, USA) according to the manufacturer's directions as described by others for the analysis of biofilms at surfaces (Kirov, Barraud). Microscopic observation and image acquisition was performed with Olympus FV1000 Confocal Inverted Microscope. Images obtained from 10 representative areas on each of triplicate samples for each surface were analysed using Image software (Abramoff et al.); Biophotonics International. 2004, 11(7), pp 36-42 and Rasband et al. Image). Bethesda Md., USA, U.S. National Institutes of Health, 1997 [symbol] 2011, available from http://imagej.hih.gov.au/ij/). The image analysis results were measured as the average area of live cells and the average area of dead cells per field of view and are reported as the average percentage coverage. Prior to comparing the groups, equality of variances was tested using Levene's test. Unequal variances were adjusted by transforming the data using square root transformation. Differences between the groups were analysed using linear mixed model ANOVA, which adjusts the correlation due to repeated observations. Post hoc multiple comparisons were done using Dunnett T3 comparison. Statistical significance was set at 5%.

### Example 1

### Characterisation of the Melimine-Coated Surfaces

XPS elemental analysis of the surfaces was carried out to verify the surface composition of the maleimide-activated glass (MAL) and after the subsequent immobilisation of cysteine-containing melimine. XPS elemental compositions are shown in Table 2.

TABLE 2
Average XPS elemental %, with standard deviation in parentheses

| | % | % | % | % | % |
|---|---|---|---|---|---|
| | Carbon | Nitrogen | Sulfur | Oxygen | Silicon |
| | (1s) | (1s) | (2p) | (1s) | (2p) |
| APTES | 46.3 (2.9) | 7.4 (0.5) | — | 29.2 (2.1) | 16.7 (1.4) |
| MAL | 55.8 (8.2) | 7.7 (0.4) | 0.1 (0.2) | 24.8 (4.2) | 10.7 (4.3) |
| CysN | 56.9 (3.3) | 10.8 (1.7) | 0.7 (0.3) | 23.0 (2.3) | 8.2 (2.1) |
| Cys13 | 58.9 (5.6) | 10.6 (2.1) | 0.6 (0.3) | 22.3 (2.8) | 7.4 (2.3) |
| CysC | 59.8 (9.7) | 10.1 (2.7) | 0.8 (0.3) | 21.1 (4.2) | 7.3 (3.5) |

Changes in the elemental compositions are indicative of surface modification by the sulfo-SMCC linker followed by peptide attachment. Indeed, the carbon concentration (C %) increased by 9.5% for MAL. The C % was further increased by 1.1%, 3.1% and 4.0% after reactions with CysN-, Cys13- and CysC-melimine respectively. The nitrogen percentage (N %) also increased after reaction with the peptides by 3.1%, 2.9% and 2.4% for CysN-, Cys13- and CysC-melimine respectively. Furthermore the sulfur concentration (% S) for the peptide surfaces increased to 0.7%, 0.6% and 0.8% from 0.1% for the MAL surface. The 0.1% sulfur on MAL is attributed to unreacted sulfo-SMCC linker adsorbed on the surface.

Comparison of the expected ratio of nitrogen/carbon with the XPS measured values was also carried out and is shown in Table 3.

TABLE 3
XPS elemental ratios - measured and calculated

| | N/C Ratio | | O/C Ratio | | O/N Ratio | |
|---|---|---|---|---|---|---|
| | XPS | Ideal | XPS | Ideal | XPS | Ideal |
| MAL | 0.14 | 0.13 | 0.44 | 0.40 | 3.22 | 3 |
| CysN | 0.19 | 0.44 | 0.40 | 0.24 | 2.13 | 0.54 |
| Cys13 | 0.18 | 0.44 | 0.38 | 0.24 | 2.10 | 0.54 |
| CysC | 0.17 | 0.44 | 0.35 | 0.24 | 2.09 | 0.54 |

For MAL the XPS measured values were in good agreement with the expected values, indicating even coverage of the linker to the APTES surface. The XPS measured nitrogen/carbon ratio for melimine-coated surfaces were lower than the expected values for 1:1 ratio of linker to peptide indicating that there are more linkers than peptides on the surface, even after peptide binding. However the surfaces showed an expected increase in the N/C ratio after peptide attachment compared to MAL due to higher nitrogen content in the peptides.

The XPS narrow scan •of C1s and N1s regions is presented in Table 4. The curve fitting results and proposed assignments to surface functionalities based on chemical shifts are also shown in Table 4.

TABLE 4
XPS binding energies for C1s and N1s and the proposed assignments

| | C1s Region | | | N1s Region | | |
|---|---|---|---|---|---|---|
| | Binding | | | Binding | | |
| | Energy | | % Peak | Energy | | % Peak |
| Surface | (eV) | Assignments | Area | (eV) | Assignments | Area |
| Maleimide- | 285.0 | C—C/C—H | 62.4 | 400.3 | N—C/N—C | 86.0 |
| Activated | 286.0 | C—C—N | 13.4 | 401.9 | N—C3 | 14.0 |
| | 286.5 | C—O | 9.4 | | | |
| | 288.6 | O═C—N | 14.9 | | | |
| CysN | 284.9 | C—H | 53.7 | 400.0 | N—C/N—C═O | 84.4 |
| | 285.9 | C—C—N | 16.0 | 401.8 | Guanidinyl-N | 15.6 |
| | 286.5 | C—O | 13.8 | | | |
| | 288.2 | O═C—N | 12.8 | | | |
| | 289.0 | C—N3 | 3.7 | | | |
| Cys13 | 285.0 | C—H | 63.3 | 400.2 | N—C/N—C═O | 96.5 |
| | 286.0 | C—N | 10.9 | 402.2 | Guanidinyl-N | 3.5 |
| | 286.6 | C—OH | 10.7 | | | |
| | 288.2 | O═C—N | 9.1 | | | |
| | 289.1 | C—N3 | 6.0 | | | |
| CysC | 284.9 | C—H | 57.7 | 400.2 | N—C/N—C═O | 100 |
| | 285.9 | C—N | 13.2 | | | |
| | 286.5 | C—O | 12.4 | | | |
| | 288.3 | O═C—N | 13.6 | | | |
| | 288.9 | C—N3 | 3.2 | | | |

The native C is spectrum of APTES samples (data not shown) showed two common carbon species with MAL samples assigned to aliphatic carbon (285.0 eV), CH₂—N/CH₂—O (286.2 eV). However two new peaks emerged for MAL surfaces corresponding to amide carbonyl and imide carbon appearing at 288.1 eV and 288.8 eV, respectively. The appearance of these species indicated the successful reaction of sulfo-SMCC's activated carbonyl with amines of APTES to form the maleimide-functionalised surface. Following the reaction of the maleimide-functionalised surfaces with Cys-melimine the 288.8 eV peak shifts slightly higher to around 289 eV. This shift can be attributed to the guanidinyl carbon of the arginine amino acid. Furthermore the ratio of the amide peak (288.1 eV) to the guanidinyl peak (289 eV) increased for melimine-coated samples.

Native N1s narrow scan for all samples showed two peaks at around 400 eV and 402 eV. The 400 eV peaks were assigned to amine and/or amide bonds of the peptides. For MAL the peak at 401.9 eV was assigned to the imide N of the maleimide. For CysN, Cys13 and CysC the 402 eV peak was assigned to guanidinyl-N found on the arginine residues of the peptide. The proportion of the amide N for all melimine-coated samples increased as expected after peptide attachment on the MAL surface.

Estimation of melimine concentration on the coated surfaces was carried out using a direct dye binding method. For the three cys-melimine samples, CysN had on average 3.5 nMol-cm⁻² of melimine, while Cys13 and CysC had 4.0 nMol-cm⁻² and 3.6 nMol-cm⁻² respectively (Table 5).

TABLE 5
Peptide concentration with estimated error (nMo1/cm²)

| ABA-MEL | CysN | Cys13 | CysC |
|---|---|---|---|
| 5.5 ± 0.7 | 3.5 ± 0.7 | 4.0 ± 0.7 | 3.6 ± 0.7 |

The estimated errors based on the calibration curve (linear fit) for three samples were found to be 0.7 nMol cm-2. Process controls showed no appreciable uptake of dye. ABA [symbol] MEL prepared as described in Chen et al., J. Bioadhesian Biafilm Res. 2009, 25, pp 517 [symbol] 524. had 5.5 nMol cm⁻² of melimine.

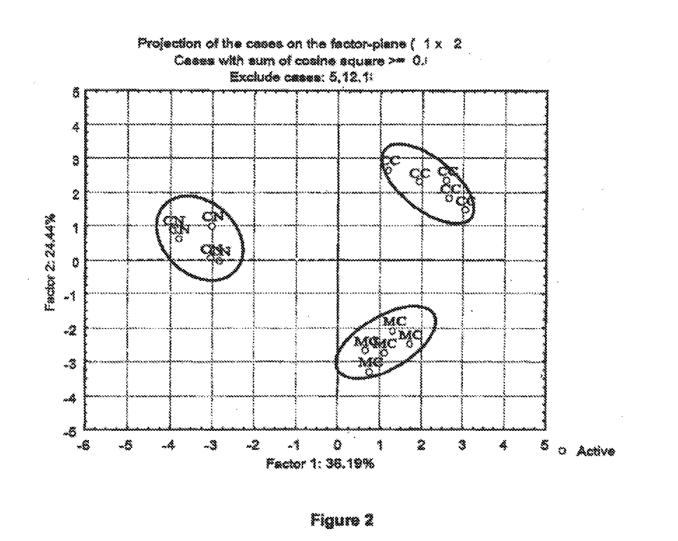

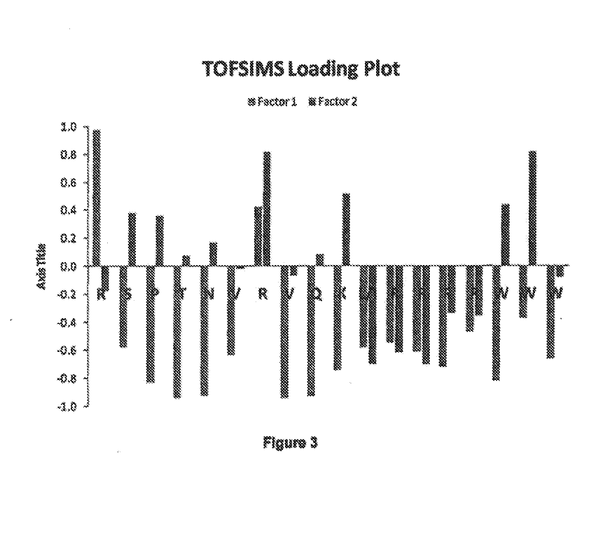

PCA was used to reduce the dimensionality of the ToF-SIMS data set into principle components which captures the main sources of variation in spectral data between samples. To interpret the orientation of the attached peptides in terms of the amino acid profiles of each protein the score (FIG. 2) and loading plots (FIG. 3) of the principal components were obtained. Two principal components, PC1 and PC2 (FIG. 3) captured approximately 74% of the difference in the spectra. Each sample group was found to form distinct clusters on the score plot (FIG. 2) with different amino acid fragment profiles for each orientation. Positive scores of PCs correspond to positive loadings on the loading plots and vice versa. Only two peaks loaded positively to PC1, corresponding to low mass arginine fragments (43 m/z CH₃N₂⁺ and 73 m/z C₂H₇N₃⁺), while all other peaks including higher mass arginine fragments scored negatively for PC1 (FIG. 3). The peaks that scored most negatively for PC1 included peaks for threonine (69 m/z C₄H₅O⁺), valine (83 m/z, C₅H₇O₄), glutamine (84 m/z C₄H₆NO⁺), and asparagine (70 m/z C₃H₄NO⁺). No significant trends could be seen in PC1.

However PC2 consists of mostly positive loading of N-terminus amino acids, while negative loading of arginine residues are observed (FIG. 3). For PC2 all arginine fragments scored negatively except one (73 m/z C₂H₇N₃⁺). Furthermore, fragments corresponding to amino acids from the N-terminus of the peptide scored positively with the exception of leucine/isoleucine, which scored negatively for PC2. The loading trends in PC2 correlate well with the expected orientation of the attached peptides on CysN and CysC. For CysN the relative higher yield of arginine residues compared with CysC suggest that the cationic portion of the peptide (consisting mostly of arginine) is oriented away from the substrate. Conversely for CysC the N-terminus is oriented away from the substrate and thus scores positively on PC2. Furthermore, Cys 13 scored in between CysN and CysC for PC2, suggesting that both ends of the peptide were exposed to the sampling depth of ToF-SIMS.

### Example 2

### Antimicrobial Activity

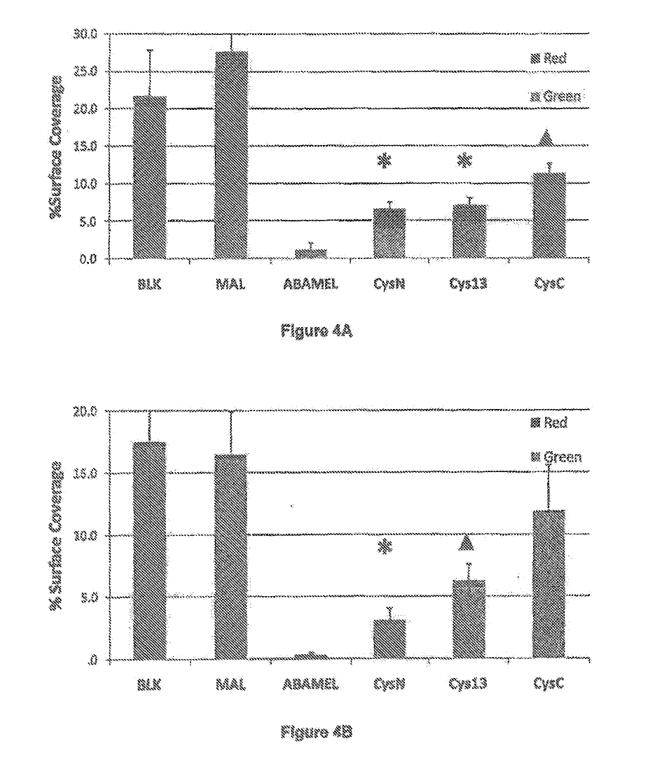

The adhesion of Pseudomonas aeruginosa and Staphylococcus aureus to the modified surfaces was evaluated using fluorescence microscopy. The images obtained were analysed using ImageJ software (Abramoff et al. J. Biophotonics International. 2004, 11(7), pp 36-42 and Rasband et al. ImageJ. Bethesda Md., USA, U.S. National Institutes of Health, 1997-2011, available from http://imagej.hih.gov.au/ij/). The areas of the surfaces covered by bacteria and the relative proportions of bacteria with intact and damaged membranes for each surface were examined by image analysis and the results are shown in FIG. 4.

For Pseudomonas aeruginosa the blank glass (BLK) and MAL surfaces showed extensive colonisation with total surface coverage of over 21.7% and 27.6% respectively. In comparison, the surface coverage of melimine-coated samples, with the exception of CysC, are significantly lower when compared to BLK. CysN and Cys13 had total coverage of 6.6% and 7.1% respectively, while CysC had significantly higher coverage at 11.3% (p<0.001). This represents reductions of 69.4%, 67.4% and 47.7% for CysN, Cys13 and CysC, respectively. While the percentage surface coverage of bacteria with damaged membranes (stained red; FIG. 4) showed no significant difference between the controls and the cys-melimine samples, the proportion of non-viable cells to total bacteria present was significantly increased for CysN and Cys13. For CysN and Cys13, 40.6% (p=0.002) and 30.1% (p<0.001) were non-viable cells, compared with BLK which had 5.8%. However, for CysC the percentage of non-viable cells was not statistically different to the controls (p>0.05).

For Staphylococcus aureus the control surfaces' total coverage at more than 16% were found to be significantly higher than CysN (p=0.009) and Cys13 (p=0.032), but not to CysC (p=0.695), with 3.0%, 6.3% and 11.8% coverage respectively. While both CysN and Cys 13 showed reductions in total bacteria of 82.7% and 64.1% respectively compared with BLK, CysN had statistically less surface coverage than Cys13 (p=0.003).

Similarly to Pseudomonas aeruginosa, the proportion of non-viable Staphylococcus aureus increased for CysN and Cys13, to 13.0% (p=0.001) and 9.8% (p=−0.034) respectively, compared with BLK at 2.2%. No statistical difference was observed in the proportion of non-viable bacteria between CysN and Cys13 (p<0.05), while both had greater percentages of red-staining cells compared to CysC (p<0.024) which was not different to the control.

### DISCUSSION

The attachment of melimine to maleimide-functionalised glass (MAL) was facilitated by addition of a single cysteine amino acid into the peptide sequence at the N-terminus (CysN), C-terminus (CysC) and at position 13 (Cys13, approximately central). The successful attachment of the modified melimine was monitored using XPS and ToF-SIMS. The spacer unit of the chosen linker is quite rigid, thereby restricting the mobility of the attached peptides, resulting in the orientation of the peptides on the surface being the principal determinant for activity. ToF-SIMS provided clear evidence that the three oriented-peptide surfaces were indeed different in their peptide surface structure.

Melimine attached via the N-terminus (CysN) was found to be the most effective surface of the three orientations, in terms of total bacterial adhesion and bacterial viability. For CysN, the cationic portion of the peptide (which consists mostly of arginine) was found oriented away from the substrate. The resulting surfaces were approximately 4-times more effective in reducing total surface coverage of S. aureus than CysC, which has the cationic portion closer to the surface. When the surfaces are challenged with P. aeruginosa, CysN was approximately 2-times more effective than CysC. Furthermore the proportion of non-viable cells to total bacteria present was significantly increased for CysN and Cys13. CysN had approximately 8 and 3 times more nonviable cells (stained red) for S. aureus and P. aeruginosa than CysC respectively. The antibacterial activity of the surfaces suggests that the distribution of hydrophobic and cationic residues within tethered melimine dictates the bacterial surface coverage as well as the viability of adherent bacterial cells.

Based on the present data the inventors believe that the availability of the cationic portion (protamine portion) of melimine to interact with bacterial membrane may be important for activity when tethered to a surface.

1. An antimicrobial cationic peptide modified to comprise a thiol functional group.

2. The peptide of claim 1, which is modified to include a thiol functional group by introduction of a thiol-containing residue into the peptide.

3. The peptide of claim 2, wherein the thiol-containing residue is cysteine.

4. The peptide of claim 3, wherein the cysteine residue is introduced into the peptide at the C-terminus or at the N-terminus.

5. The peptide of claim 1, which is arginine rich.

6. The peptide of claim 5, wherein the peptide is arginine rich in the C-terminal portion.

7. The peptide of claim 1, which is arginine and lysine rich.

8. The peptide of claim 7, which is arginine and lysine rich in the C-terminal portion.

9. The peptide of claim 1, comprising between about 10 and about 60 amino acids.

10. The peptide of claim 1, wherein the peptide that is modified is melimine, protamine, lactoferricin, protattin, or a peptide comprising one of the following amino acid sequences:
(SEQ ID NO: 5)
TLISWIQRPRVS;
(SEQ ID NO: 6)
TLISWIKNKRKQRPRVS;
(SEQ ID NO: 7)
TLISWIQRPRVSRRRRRRGGRRRR;
or
(SEQ ID NO: 8)
KNKRKRRRRRRGGRRRR.

11. The peptide of claim 10, wherein the melimine peptide that is modified has the amino acid sequence set forth in SEQ ID NO:1, the protamine peptide that is modified has the amino acid sequence set forth in SEQ ID NO:2, the lactoferricin peptide that is modified has the amino acid sequence set forth in SEQ ID NO:3, and the protattin peptide that is modified has the amino acid sequence set forth in SEQ ID NO:4.

12. A peptide according to claim 1, comprising one of the following amino acid sequences:
(SEQ ID NO: 9)
CTLISWIKNKRKQRPRVSRRRRRRGGRRRR,
(SEQ ID NO: 10)
TLISWIKNKRKQRPRVSRRRRRRGGRRRRC,
or
(SEQ ID NO: 11)
TLISWIKNKRKQCRPRVSRRRRRRGGRRRR.

13. An antimicrobial composition comprising a cationic peptide as defined in claim 1.

14. A method for improving the antimicrobial activity of an antimicrobial cationic peptide, the method comprising modifying the peptide to include a thiol functional group.

15. The method of claim 14, wherein the peptide is modified to include a thiol functional group by introduction of a thiol-containing residue into the peptide.

16. The method of claim 15, wherein the thiol-containing residue is cysteine.

17. The method of claim 16, wherein the cysteine residue is introduced into the peptide at the C-terminus or at the N-terminus.

18. The method of claim 14, wherein the peptide that is modified is melimine, protamine, lactoferricin, protattin, or a peptide comprising one of the following amino acid sequences:
(SEQ ID NO: 5)
TLISWIQRPRVS;
(SEQ ID NO: 6)
TLISWIKNKRKQRPRVS;
(SEQ ID NO: 7)
TLISWIQRPRVSRRRRRRGGRRRR;
or
(SEQ ID NO: 8)
KNKRKRRRRRRGGRRRR.

19. The method of claim 18, wherein the melimine peptide that is modified has the amino acid sequence set forth in SEQ ID NO:1, the protamine peptide that is modified has the amino acid sequence set forth in SEQ ID NO:2, the lactoferricin peptide that is modified has the amino acid sequence set forth in SEQ ID NO:3, and the protattin peptide that is modified has the amino acid sequence set forth in SEQ ID NO:4.

20. A method for eliminating or inhibiting the growth of one or more microorganisms or the colonisation of an environment by the microorganisms, the method comprising contacting the one or more microorganisms, or an environment inhabited by the microorganisms, with an effective amount of a cationic peptide as defined in claim 1.

21. A method for inhibiting the adherence of one or more microorganisms to a surface, the method comprising attaching to the surface at least one modified antimicrobial cationic peptide according to claim 1, wherein the peptide is directly or indirectly attached to the surface via the thiol functional group of the modified peptide.

22. The method of claim 21, wherein the thiol functional group is part of a cysteine residue.

23. The method of claim 22, wherein the cysteine residue is located at the N terminus or C-terminus of the modified peptide.

24. The method of claim 21, wherein the surface is a solid surface.

25. The method of claim 24, wherein the solid surface is colonised by, or is capable of being colonised by, the microorganisms.

26. The method of claim 21, wherein the peptide is directly or indirectly covalently attached to the surface via the thiol functional group.

27. The method of claim 26, wherein the peptide is indirectly covalently attached to the surface via a succinimidylene linker attached to the thiol functional group.

28. The method of claim 27, wherein the peptide is indirectly covalently attached to the surface via a succinimidylene linker attached to the thiol functional group and a spacer molecule attached to the succinimidylerie linker and, directly or indirectly, to the surface.

29. The method of claim 28, wherein the spacer molecule is C₁-C₂₀ perfluoroalkylene, C₃-C₆ cycloalkylene, C₁-C₂₀ alkylene, polyethylene glycol, or combinations thereof.

30. The method of claim 29, wherein the spacer molecule is C₃-C₆ cycloalkylene, C₁-C₆ alkylene, polyethylene glycol having between 2 and 20 ethylene glycol units, or combinations thereof.

31. The method of claim 30, wherein the spacer molecule has the following structure: 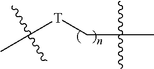
wherein T is —(CH₂CH₂O)ₘ—, C₁-C₆ alkylene or C₃-C₆ cycloalkylene, n is a number between 0 and 5 and m is a number between 1 and 10.

32. The method of claim 31, wherein T is C₁-C₆ alkylene or C₃-C₆ cycloalkylene, and n is 0, 1, 2 or 3.

33. The method of claim 28, wherein the spacer molecule is indirectly attached to the surface via a bivalent functional group comprising an amide.

34. The method of claim 33, wherein the bivalent functional group comprising an amide is a group of the following formula: 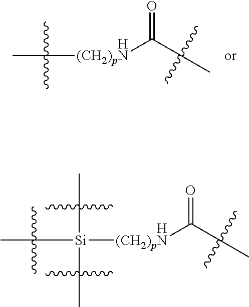
wherein p is a number between 1 and 6.

35. The method of claim 28, wherein the peptide is attached to the surface via the following groups: 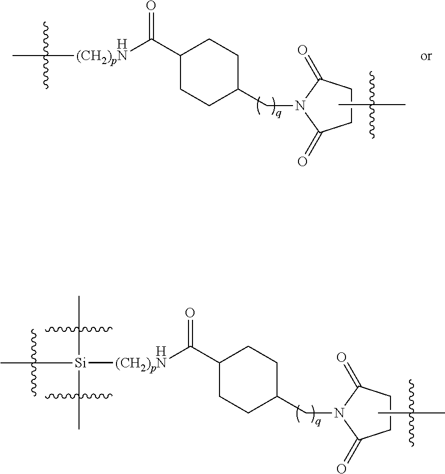
wherein p is a number between 1 and 3 and q is a number between 0 and 2.

36. The method of claim 35, wherein p is 3 and q is 1.

37. The method of claim 24, wherein the solid surface comprises a polymer.

38. The method of claim 37, wherein the polymer is a hydrogel, a silicon hydrogel, a polymer or copolymer of 2-hydroxyethylmethacrylate, silicon rubber, polyurethane, polypropylene, polyethylene, polyacrylamide, polytetrafluoroethylene, or a biodegradable polymer.

39. The method of claim 24, wherein the solid surface is the surface of a medical device.

40. The method of claim 39, wherein the medical device is a contact lens, fluid collection bag, sensor, hydrogel bandage, tubing, stent, heart valve, an implant, a catheter or carrier for antibiotic, diagnostic or therapeutic agents.

41. The method of claim 40, wherein the implant is a hearing implant, a knee implant, a hip implant, an implantable electrode or an implantable neuroprosthetic electrode array.

42. The method of claim 24, wherein the solid surface is a glass or metal surface or a metal-containing surface.

43. The method of claim 20, wherein the one or more microorganisms are bacteria, fungi, yeast or protozoa.

44. The method of claim 43, wherein the microorganisms are bacteria.

45. The method of claim 44, wherein the bacteria are Staphylococcus aureus or Pseudomonas aeruginosa.

46. A device, wherein the surface of the device comprises at least one modified antimicrobial cationic peptide according to the first aspect, wherein the peptide is directly or indirectly attached to the surface of the device via the thiol functional group of the modified peptide.

47. The device of claim 46, wherein the peptide is directly or indirectly covalently attached to the surface of the device via the thiol functional group.

48. The device of claim 47, wherein the peptide is indirectly covalently attached to the surface of the device via a succinimidylene linker attached to the thiol functional group.

49. The device of claim 48, wherein the peptide is indirectly covalently attached to the surface of the device via a succinimidylene linker attached to the thiol functional group and a spacer molecule attached to the succinimidylene linker and, directly or indirectly, to the surface of the device.

50. The device of claim 49, wherein the spacer molecule is C₁-C₂₀ perfluoroalkylene, C₃-C₆ cycloalkylene, C₁-C₂₀ alkylene, polyethylene glycol, or combinations thereof.

51. The device of claim 50, wherein the spacer molecule is C₃-C₆ cycloalkylene, C₁-C₆ alkylene, polyethylene glycol having between 2 and 20 ethylene glycol units, or combinations thereof.

52. The device of claim 51, wherein the spacer molecule has the following structure: 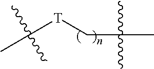
wherein T is —(CH₂CH₂O)ₘ—, C₁-C₆ alkylene or C₃-C₆ cycloalkylene, n is a number between 0 and 5 and m is a number between 1 and 10.

53. The device of claim 52, wherein T is C₁-C₆ alkylene or C₃-C₆ cycloalkylene, and n is 0, 1, 2 or 3.

54. The device of claim 49, wherein the spacer molecule is indirectly attached to the surface via a bivalent functional group comprising an amide.

55. The device of claim 54, wherein the bivalent functional group comprising an amide is a group of the following formula: 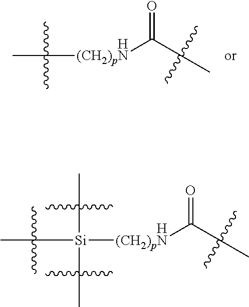
wherein p is a number between 1 and 6.

56. The device of claim 49, wherein the peptide is attached to the surface via the following groups: 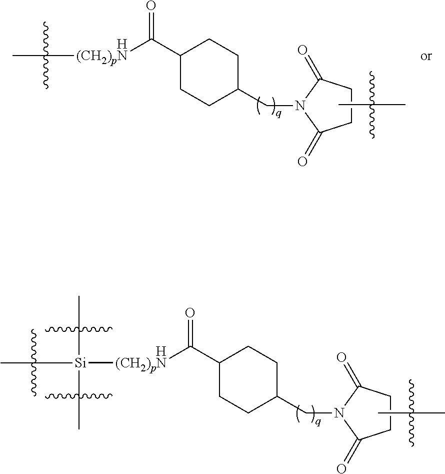
wherein p is a number between 1 and 3 and q is a number between 0 and 2.

57. The device of claim 56, wherein p is 3 and q is 1.

58. The device of claim 46, wherein the surface of the device comprises a polymer.

59. The device of claim 58, wherein the polymer is a hydrogel, a silicon hydrogel, a polymer or copolymer of 2-hydroxyethylmethacrylate, silicon rubber, polyurethane, polypropylene, polyethylene, polyacrylamide, polytetrafluoroethylene, or a biodegradable polymer.

60. The device of claim 46, wherein the device is a medical device.

61. The device of claim 60, wherein the medical device is a contact lens, fluid collection bag, sensor, hydrogel bandage, tubing, stent, heart valve, an implant, a catheter or carrier for antibiotic, diagnostic or therapeutic agents.

62. The device of claim 61, wherein the implant is a hearing implant, a knee implant, a hip implant, an implantable electrode or an implantable neuroprosthetic electrode array.

63. A method for modulating the location of attachment of at least one antimicrobial cationic peptide as defined in claim 1, to a surface, the method comprising introducing a thiol functional group into the peptide at a position of the peptide where it is desired to attach the peptide to the surface.

64. The method of claim 63, wherein the surface is a solid surface.

65. The method of claim 63, wherein the thiol functional group is introduced into the peptide as part of a cysteine residue.

66. The method of claim 62, wherein the cysteine residue is introduced into the peptide at the C-terminus or at the N-terminus of the peptide.

67. A method for improving the activity of an antimicrobial cationic peptide as defined in claim 1, the method comprising modifying the peptide to include a thiol functional group and attaching the peptide to a surface via the thiol functional group.

68. The method of claim 67, wherein the surface is a solid surface.

69. The method of claim 68, wherein the peptide is modified to include a thiol functional group by introduction of a cysteine residue into the peptide.

70. The method of claim 69, wherein the peptide is modified to include a cysteine residue at the C-terminus or at the N-terminus of the peptide.

71. A method for preparing a device having at least one surface, the method comprising reacting the at least one surface with at least one modified antimicrobial cationic peptide as defined in claim 1, wherein reaction occurs at the thiolfunctional group of the modified peptide.

72. The method of claim 71, wherein the surface of the device comprises a polymer.

73. The method of claim 72, wherein the polymer is a hydrogel, a silicon hydrogel, a polymer or copolymer of 2-hydroxyethylmethacrylate, silicon rubber, polyurethane, polypropylene, polyethylene, polyacrylamide, polytetrafluoroethylene, or a biodegradable polymer.

74. The method of claim 71, wherein the device is a medical device.

75. The method of claim 74, wherein the medical device is a contact lens, fluid collection bag, sensor, hydrogel bandage, tubing, stent, heart valve, an implant, a catheter or carrier for antibiotic, diagnostic or therapeutic agents.

76. The method of claim 75, wherein the implant is a hearing implant, a knee implant, a hip implant, an implantable electrode or an implantable neuroprosthetic electrode array.

77. The method of claim 71, wherein the surface comprises a maleimidyl group attached thereto which reacts with the thiol functional group.

78. The method of claim 77, wherein the maleimidyl group is attached to the surface via a spacer molecule.

79. The method of claim 78, wherein the spacer molecule is C₁-C₂₀ perfluoroalkylene, C₃-C₆ cycloalkylene, C₁-C₂₀ alkylene, polyethylene glycol, or combinations thereof.

80. The method of claim 79, wherein the spacer molecule is C₃-C₆ cycloalkylene, C₁-C₆ alkylene, polyethylene glycol having between 2 and 20 ethylene glycol units, or combinations thereof.

81. The method of claim 80, wherein the spacer molecule has the following structure: 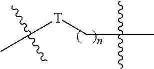
wherein T is —(CH₂CH₂O)ₘ—, C₁-C₆ alkylene or C₃-C₆ cycloalkylene, n is a number between 0 and 5 and m is a number between 1 and 10.

82. The method of claim 81, wherein T is C₁-C₆ alkylene or C₃-C₆ cycloalkylene, and n is 0, 1, 2 or 3.

83. The method of claim 78, wherein the spacer molecule is indirectly attached to the surface via a bivalent functional group comprising an amide.

84. The method of claim 83, wherein the maleimidyl group is attached to the surface as follows: 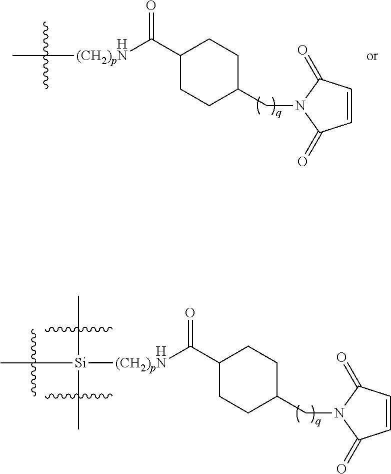
wherein p is a number between 1 and 3 and q is a number between 0 and 2.
